(19) United States
(12) Patent Application Publication
(10) Pub. No.: US 2006/0146937 A1
(43) Pub. Date: Jul. 6, 2006

(54) Three-dimensional wavelet video coding using motion-compensated temporal filtering on overcomplete wavelet expansions

(75) Inventors: Jong Chul Ye, Clifton Park, NY (US); Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/546,623

(22) PCT Filed: Feb. 23, 2004
(86) PCT No.: PCT/IB04/00489

§ 371 Date: Aug. 23, 2005

Related U.S. Application Data
(60) Provisional application No. 60/449,696, filed on Feb. 25, 2003.
(60) Provisional application No. 60/482,954, filed on Jun. 27, 2003.

(51) Int. Cl. H04B 1/66; H04N 11/02; H04N 7/12; H04N 11/04

(52) U.S. Cl. 375/240.19; 375/240.16

(57) ABSTRACT

Encoding and decoding methods and apparatuses are provided for encoding and decoding video frames. The encoding method (700) and apparatus (110) use three dimensional lifting in an overcomplete wavelet domain to compress video frames. The decoding method (800) and apparatus (118) also use three dimensional lifting in the overcomplete wavelet domain to decompress the video frames.

This application claims the benefit under 35 U.S.C. § 11 9(e) of U.S. Patent Application Ser. No. 60/449,696 filed on Feb. 25, 2003.

This disclosure relates generally to video coding systems and more specifically to video coding using three dimensional lifting.

Real-time streaming of multimedia content over data networks has become an increasingly common application in recent years. For example, multimedia applications such as news-on-demand, live network television viewing, and video conferencing often rely on end-to-end streaming of video information. Streaming video applications typically include a video transmitter that encodes and transmits a video signal over a network to a video receiver that decodes and displays the video signal in real time.

Scalable video coding is typically a desirable feature for many multimedia applications and services. Scalability allows processors with lower computational power to decode only a subset of a video stream, while processors with higher computational power can decode the entire video stream. Another use of scalability is in environments with a variable transmission bandwidth. In those environments, receivers with lower-access bandwidth receive and decode only a subset of the video stream, while receivers with higher-access bandwidth receive and decode the entire video stream.

Several video scalability approaches have been adopted by lead video compression standards such as MPEG-2 and MPEG-4. Temporal, spatial, and quality (e.g., signal-noise ratio or “SNR”) scalability types have been defined in these standards. These approaches typically include a base layer (BL) and an enhancement layer (EL). The base layer of a video stream represents, in general, the minimum amount of data needed for decoding that stream. The enhancement layer of the stream represents additional information, which enhances the video signal representation when decoded by the receiver.

Many current video coding systems use motion-compensated predictive coding for the base layer and discrete cosine transform (DCT) residual coding for the enhancement layer. In these systems, temporal redundancy is reduced using motion compensation, and spatial resolution is reduced by transform coding the residue of the motion compensation. However, these systems are typically prone to problems such as error propagation (or drift) and a lack of true scalability.

This disclosure provides an improved coding system that uses three dimensional (3D) lifting. In one aspect, a 3D lifting structure is used for fractional-accuracy motion compensated temporal filtering (MCTF) in an overcomplete wavelet domain. The 3D lifting structure may provide a trade-off between resiliency and efficiency by allowing different accuracies for motion estimation, which may be taken advantage of during streaming over varying channel conditions.

For a more complete understanding of the this disclosure, reference is now made to the following descriptions taken in conjunction with the accompanying drawings, in which:

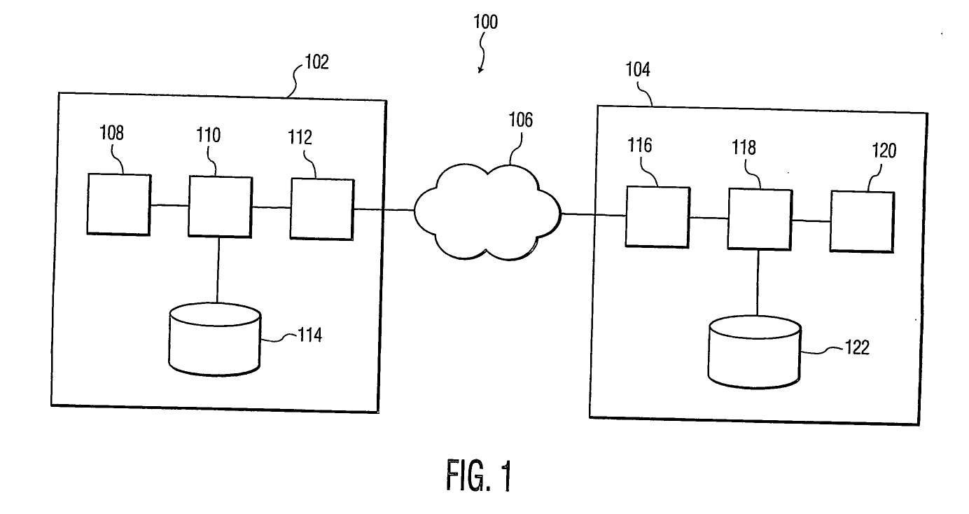

FIG. 1 illustrates an example video transmission system according to one embodiment of this disclosure;

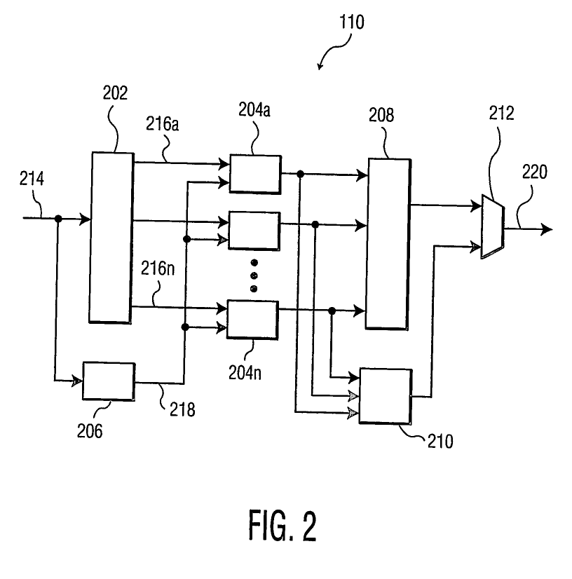

FIG. 2 illustrates an example video encoder according to one embodiment of this disclosure;

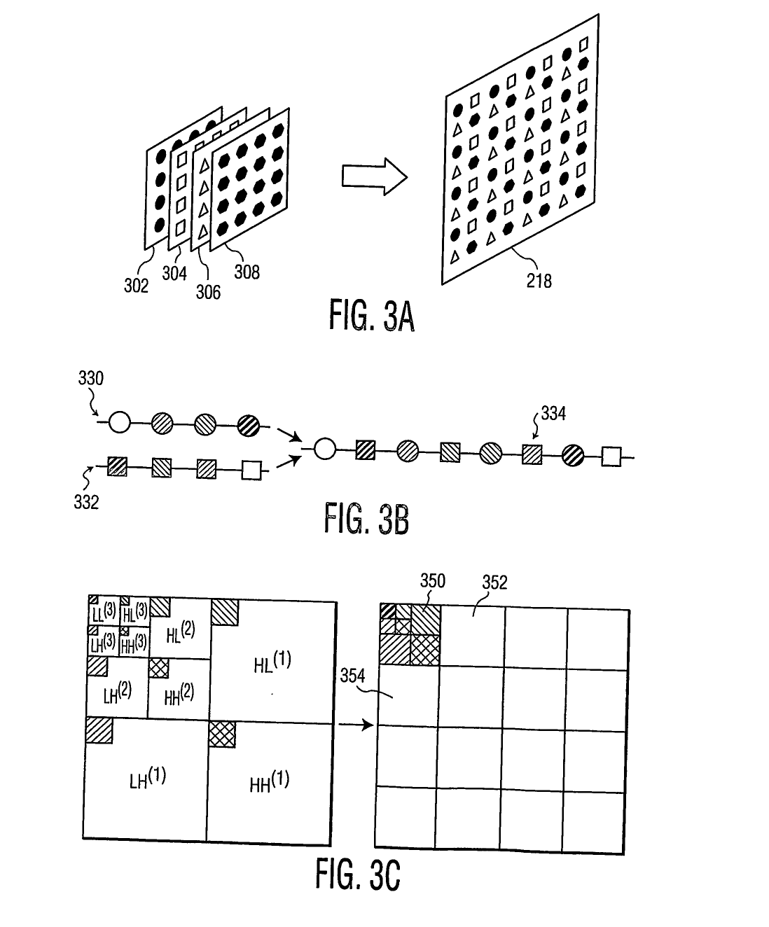

FIGS. 3A-3C illustrate generation of an example reference frame by overcomplete wavelet expansion according to one embodiment of this disclosure;

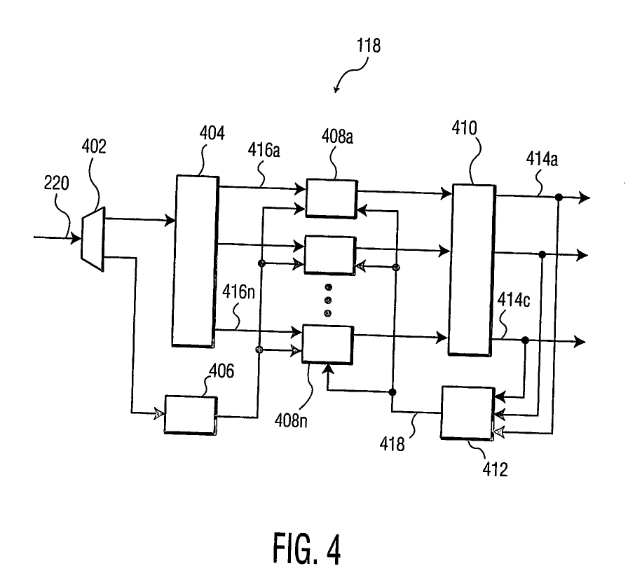

FIG. 4 illustrates an example video decoder according to one embodiment of this disclosure;

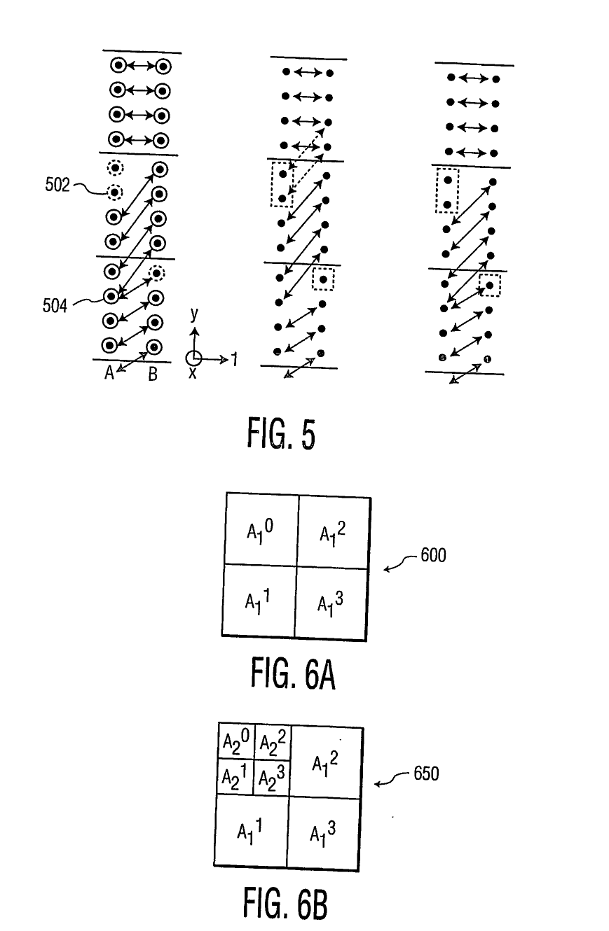

FIG. 5 illustrates an example motion compensated temporal filtering according to one embodiment of this disclosure;

FIGS. 6A and 6B illustrate example wavelet decompositions according to one embodiment of this disclosure;

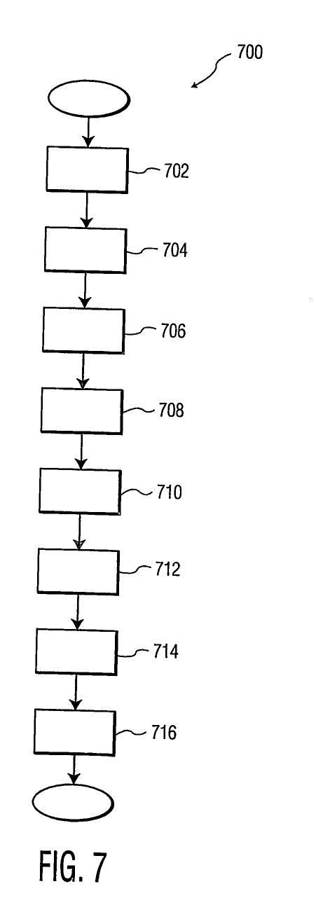

FIG. 7 illustrates an example method for encoding video information using 3D lifting in an overcomplete wavelet domain according to one embodiment of this disclosure; and

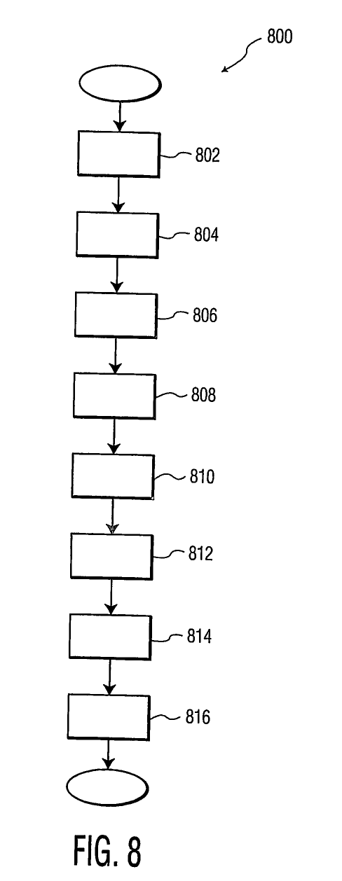

FIG. 8 illustrates an example method for decoding video information using 3D lifting in an overcomplete wavelet domain according to one embodiment of this disclosure.

FIGS. 1 through 8, discussed below, and the various embodiments described in this patent document are by way of illustration only and should not be construed in any way to limit the scope of the invention. Those skilled in the art will understand that the principles of the invention may be implemented in any suitably arranged video encoder, video decoder, or other apparatus, device, or structure.

FIG. 1 illustrates an example video transmission system 100 according to one embodiment of this disclosure. In the illustrated embodiment, the system 100 includes a streaming video transmitter 102, a streaming video receiver 104, and a data network 106. Other embodiments of the video transmission system may be used without departing from the scope of this disclosure.

The streaming video transmitter 102 streams video information to the streaming video receiver 104 over the network 106. The streaming video transmitter 102 may also stream audio or other information to the streaming video receiver 104. The streaming video transmitter 102 includes any of a wide variety of sources of video frames, including a data network server, a television station transmitter, a cable network, or a desktop personal computer.

In the illustrated example, the streaming video transmitter 102 includes a video frame source 108, a video encoder 110, an encoder buffer 112, and a memory 114. The video frame source 108 represents any device or structure capable of generating or otherwise providing a sequence of uncompressed video frames, such as a television antenna and receiver unit, a video cassette player, a video camera, or a disk storage device capable of storing a “raw” video clip.

The uncompressed video frames enter the video encoder 110 at a given picture rate (or “streaming rate”) and are compressed by the video encoder 110. The video encoder 110 then transmits the compressed video frames to the encoder buffer 112. The video encoder 110 represents any suitable encoder for coding video frames. In some embodiments, the video encoder 110 uses 3D lifting for fractional-accuracy MCTF in an overcomplete wavelet domain. One example of the video encoder 110 is shown in FIG. 2, which is described below.

The encoder buffer 112 receives the compressed video frames from the video encoder 110 and buffers the video frames in preparation for transmission across the data network 106. The encoder buffer 112 represents any suitable buffer for storing compressed video frames.

The streaming video receiver 104 receives the compressed video frames streamed over the data network 106 by the streaming video transmitter 102. In the illustrated example, the streaming video receiver 104 includes a decoder buffer 116, a video decoder 118, a video display 120, and a memory 122. Depending on the application, the streaming video receiver 104 may represent any of a wide variety of video frame receivers, including a television receiver, a desktop personal computer, or a video cassette recorder. The decoder buffer 116 stores compressed video frames received over the data network 106. The decoder buffer 116 then transmits the compressed video frames to the video decoder 118 as required. The decoder buffer 116 represents any suitable buffer for storing compressed video frames.

The video decoder 118 decompresses the video frames that were compressed by the video encoder 110. The compressed video frames are scalable, allowing the video decoder 118 to decode part or all of the compressed video frames. The video decoder 118 then sends the decompressed frames to the video display 120 for presentation. The video decoder 118 represents any suitable decoder for decoding video frames. In some embodiments, the video decoder 118 uses 3D lifting for fractional-accuracy inverse MCTF in an overcomplete wavelet domain. One example of the video decoder 118 is shown in FIG. 4, which is described below. The video display 120 represents any suitable device or structure for presenting video frames to a user, such as a television, PC screen, or projector.

In some embodiments, the video encoder 110 is implemented as a software program executed by a conventional data processor, such as a standard MPEG encoder. In these embodiments, the video encoder 110 includes a plurality of computer executable instructions, such as instructions stored in the memory 114. Similarly, in some embodiments, the video decoder 118 is implemented as a software program executed by a conventional data processor, such as a standard MPEG decoder. In these embodiments, the video decoder 118 includes a plurality of computer executable instructions, such as instructions stored in the memory 122. The memories 114, 122 each represents any volatile or non-volatile storage and retrieval device or devices, such as a fixed magnetic disk, a removable magnetic disk, a CD, a DVD, magnetic tape, or a video disk. In other embodiments, the video encoder 110 and video decoder 118 are each implemented in hardware, software, firmware, or any combination thereof.

The data network 106 facilitates communication between components of the system 100. For example, the network 106 may communicate Internet Protocol (IP) packets, frame relay frames, Asynchronous Transfer Mode (AT) cells, or other suitable information between network addresses or components. The network 106 may include one or more local area networks (LANs), metropolitan area networks (MANs), wide area networks (WANs), all or a portion of a global network such as the Internet, or any other communication system or systems at one or more locations. The network 106 may also operate according to any appropriate type of protocol or protocols, such as Ethernet, IP, X.25, frame relay, or any other packet data protocol.

Although FIG. 1 illustrates one example of a video transmission system 100, various changes may be made to FIG. 1. For example, the system 100 may include any number of streaming video transmitters 102, streaming video receivers 104, and networks 106.

FIG. 2 illustrates an example video encoder 110 according to one embodiment of this disclosure. The video encoder 110 shown in FIG. 2 may be used in the video transmission system 100 shown in FIG. 1. Other embodiments of the video encoder 110 could be used in the video transmission system 100, and the video encoder 110 shown in FIG. 2 could be used in any other suitable device, structure, or system without departing from the scope of this disclosure.

In the illustrated example, the video encoder 110 includes a wavelet transformer 202. The wavelet transformer 202 receives uncompressed video frames 214 and transforms the video frames 214 from a spatial domain to a wavelet domain. This transformation spatially decomposes a video frame 214 into multiple bands 216a-216n using wavelet filtering, and each band 216 for that video frame 214 is represented by a set of wavelet coefficients. The wavelet transformer 202 uses any suitable transform to decompose a video frame 214 into multiple video or wavelet bands 216. In some embodiments, a frame 214 is decomposed into a first decomposition level that includes a low-low (LL) band, a low-high (LH) band, a high-low (HL) band, and a high-high (HH) band. One or more of these bands may be further decomposed into additional decomposition levels, such as when the LL band is further decomposed into LLLL, LLLH, LLHL, and LLHH sub-bands.

The wavelet bands 216 are provided to a plurality of motion compensated temporal filters (MCTFs) 204a-204n. The MCTFs 204 temporally filter the video bands 216 and remove temporal correlation between the frames 214. For example, the MCIFs 204 may filter the video bands 216 and generate high-pass frames and low-pass frames for each of the video bands 216.

In some embodiments, groups of frames are processed by the MCTFs 204. In particular embodiments, each MCTF 204 includes a motion estimator and a temporal filter. The motion estimators in the MCTFs 204 generate one or more motion vectors, which estimate the amount of motion between a current video frame and a reference frame and produces one or more motion vectors. The temporal filters in the MCTFs 204 use this information to temporally filter a group of video frames in the motion direction. In other embodiments, the MCTFs 204 could be replaced by unconstrained motion compensated temporal filters (UMCTFs).

In some embodiments, interpolation filters in the motion estimators can have different coefficient values. Because different bands 216 may have different temporal correlations, this may help to improve the coding performance of the MCTFs 204. Also, different temporal filters may be used in the MCTFs 204. In some embodiments, bi-directional temporal filters are used for the lower bands 216 and forward-only temporal filters are used for the higher bands 216. The temporal filters can be selected based on a desire to minimize a distortion measure or a complexity measure. The temporal filters could represent any suitable filters, such as lifting filters that use prediction and update steps designed differently for each band 216 to increase or optimize the efficiency/complexity constraint.

In addition, the number of frames grouped together and processed by the MCTFs 204 can be adaptively determined for each band 216. In some embodiments, lower bands 216 have a larger number of frames grouped together, and higher bands have a smaller number of frames grouped together. This allows, for example, the number of frames grouped together per band 216 to be varied based on the characteristics of the sequence of frames 214 or complexity or resiliency requirements. Also, higher spatial frequency bands 216 can be omitted from longer-term temporal filtering. As a particular example, frames in the LL, LH and HL, and HH bands 216 can be placed in groups of eight, four, and two frames, respectively. This allows a maximum decomposition level of three, two, and one, respectively. The number of temporal decomposition levels for each of the bands 216 can be determined using any suitable criteria, such as frame content, a target distortion metric, or a desired level of temporal scalability for each band 216. As another particular example, frames in each of the LL, LH and HL, and HH bands 216 may be placed in groups of eight frames.

As shown in FIG. 2, the MCTFs 204 operate in the wavelet domain. In conventional encoders, motion estimation and compensation in the wavelet domain is typically inefficient because the wavelet coefficients are not shift-invariant. This inefficiency may be overcome using a low band shifting technique. In the illustrated embodiment, a low band shifter 206 processes the input video frames 214 and generates one or more overcomplete wavelet expansions 218. The MCTFs 204 use the overcomplete wavelet expansions 218 as reference frames during motion estimation. The use of the overcomplete wavelet expansions 218 as the reference frames allows the MCTFs 204 to estimate motion to varying levels of accuracy. As a particular example, the MCTFs 204 could employ a 1/16 pel accuracy for motion estimation in the LL band 216 and a ⅛ pel accuracy for motion estimation in the other bands 216.

In some embodiments, the low band shifter 206 generates an overcomplete wavelet expansion 218 by shifting the lower bands of the input video frames 214. The generation of the overcomplete wavelet expansion 218 by the low band shifter 206 is shown in FIGS. 3A-3C. In this example, different shifted wavelet coefficients corresponding to the same decomposition level at a specific spatial location is referred to as “cross-phase wavelet coefficients.” As shown in FIG. 3A, each phase of the overcomplete wavelet expansion 218 is generated by shifting the wavelet coefficients of the next-finer level LL band and applying one level wavelet decomposition. For example, wavelet coefficients 302 represent the coefficients of the LL band without shift. Wavelet coefficients 304 represent the coefficients of the LL band after a (1,0) shift, or a shift of one position to the right. Wavelet coefficients 306 represent the coefficients of the LL band after a (0,1) shift, or a shift of one position down. Wavelet coefficients 308 represent the coefficients of the LL band after a (1,1) shift, or a shift of one position to the right and one position down.

The four sets of wavelet coefficients 302-308 in FIG. 3A are augmented or combined to generate the overcomplete wavelet expansion 218. FIG. 3B illustrates one example of how the wavelet coefficients 302-308 may be augmented or combined to produce the overcomplete wavelet expansion 218. As shown in FIG. 3B, two sets of wavelet coefficients 330, 332 are interleaved to produce a set of overcomplete wavelet coefficients 334. The overcomplete wavelet coefficients 334 represent the overcomplete wavelet expansion 218 shown in FIG. 3A. The interleaving is performed such that the new coordinates in the overcomplete wavelet expansion 218 correspond to the associated shift in the original spatial domain. This interleaving technique can also be used recursively at each decomposition level and can be directly extended for 2D signals. The use of interleaving to generate the overcomplete wavelet coefficients 334 may enable more optimal or optimal sub-pixel accuracy motion estimation and compensation in the video encoder 110 and video decoder 118 because it allows consideration of cross-phase dependencies between neighboring wavelet coefficients. Although FIG. 3B illustrates two sets of wavelet coefficients 330, 332 being interleaved, any number of coefficient sets could be interleaved together to form the overcomplete wavelet coefficients 334, such as four sets of wavelet coefficients.

Part of the low band shifting technique involves the generation of wavelet blocks as shown in FIG. 3C. In some embodiments, during wavelet decomposition, coefficients at a given scale (except for coefficients in the highest frequency band) can be related to a set of coefficients of the same orientation at finer scales. In conventional coders, this relationship is exploited by representing the coefficients as a data structure called a “wavelet tree.” In the low band shifting technique, the coefficients of each wavelet tree rooted in the lowest band are rearranged to form a wavelet block 350 as shown in FIG. 3C. Other coefficients are similarly grouped to form additional wavelet blocks 352, 354. The wavelet blocks shown in FIG. 3C provide a direct association between the wavelet coefficients in that wavelet block and what those coefficients represent spatially in an image. In particular embodiments, related coefficients at all scales and orientations are included in each of the wavelet blocks.

In some embodiments, the wavelet blocks shown in FIG. 3C are used during motion estimation by the MCTFs 204. For example, during motion estimation, each MCTF 204 finds the motion vector (dₓ, d_{y}) that generates a minimum mean absolute difference (MAD) between the current wavelet block and a reference wavelet block in the reference frame. For example, the mean absolute difference of the k-th wavelet block in FIG. 3C could be computed as follows:

$${MAD}_{k} ( dx , dy ) = {\sum }_{i = 1}^{3} {\sum }_{{x}_{i} = {x}_{i , k}}^{{x}_{i , k} + M / {2}^{i}} {\sum }_{{y}_{i} = {y}_{i , k}}^{{y}_{i , k} + N / {2}^{i}} \{ \vert {HL}_{cur}^{( i )} ( {x}_{i} , {y}_{i} ) - {LBS\_HL}_{ref}^{( i )} ( {2}^{i} {x}_{i} + dx , {2}^{i} {y}_{i} + dy ) \vert + \vert {LH}_{cur}^{( i )} ( {x}_{i} , {y}_{i} ) - {LBS\_LH}_{ref}^{( i )} ( {2}^{i} {x}_{i} + dx , {2}^{i} {y}_{i} + dy ) \vert + \vert {HH}_{cur}^{( i )} ( {x}_{i} , {y}_{i} ) - {LBS\_HH}_{ref}^{( i )} ( {2}^{i} {x}_{i} + dx , {2}^{i} {y}_{i} + dy ) \vert \} + {\sum }_{{x}_{i} = {x}_{3 , k}}^{{x}_{3 , k} + M / {2}^{i}} {\sum }_{{y}_{i} = {y}_{3 , k}}^{{y}_{3 , k} + N / {2}^{i}} \vert {LL}_{cur}^{( i )} ( {x}_{i} , {y}_{i} ) - {LBS\_LL}_{ref}^{( i )} ( {2}^{i} {x}_{i} + dx , {2}^{i} {y}_{i} + dy ) \vert \qquad ( 1 )$$

where, for example, LBS_HL_{ref}⁽¹⁾ (x, y) denotes the extended HL band of the reference frame using the interleaving technique described above. Equation (1) works even when (dₓ, d_{y}) are non-integer values, while previous low band shifting techniques could not. Also, in particular embodiments, using this coding scheme with wavelet blocks does not incur any motion vector overhead.

Returning to FIG. 2, the MCTFs 204 provide filtered video bands to an Embedded Zero Block Coding (EZBC) coder 208. The EZBC coder 208 analyzes the filtered video bands and identifies correlations within the filtered bands 216 and between the filtered bands 216. The EZBC coder 208 uses this information to encode and compress the filtered bands 216. As a particular example, the EZBC coder 208 could compress the high-pass frames and low-pass frames generated by the MCTFs 204.

The MCTFs 204 also provide motion vectors to a motion vector encoder 210. The motion vectors represent motion detected in the sequence of video frames 214 provided to the video encoder 110. The motion vector encoder 210 encodes the motion vectors generated by the MCTFs 204. The motion vector encoder 210 uses any suitable encoding technique, such as a texture based coding technique like DCT coding.

Taken together, the compressed and filtered bands 216 produced by the EZBC coder 208 and the compressed motion vectors produced by the motion vector encoder 210 represent the input video frames 214. A multiplexer 212 receives the compressed and filtered bands 216 and the compressed motion vectors and multiplexes them onto a single output bitstream 220. The bitstream 220 is then transmitted by the streaming video transmitter 102 across the data network 106 to a streaming video receiver 104.

FIG. 4 illustrates one example of a video decoder 118 according to one embodiment of this disclosure. The video decoder 118 shown in FIG. 4 may be used in the video transmission system 100 shown in FIG. 1. Other embodiments of the video decoder 118 could be used in the video transmission system 100, and the video decoder 118 shown in FIG. 4 could be used in any other suitable device, structure, or system without departing from the scope of this disclosure.

In general, the video decoder 118 performs the inverse of the functions that were performed by the video encoder 110 of FIG. 2, thereby decoding the video frames 214 encoded by the encoder 110. In the illustrated example, the video decoder 118 includes a demultiplexer 402. The demultiplexer 402 receives the bitstream 220 produced by the video encoder 110. The demultiplexer 402 demultiplexes the bitstream 220 and separates the encoded video bands and the encoded motion vectors.

The encoded video bands are provided to an EZBC decoder 404. The EZBC decoder 404 decodes the video bands that were encoded by the EZBC coder 208. For example, the EZBC decoder 404 performs an inverse of the encoding technique used by the EZBC coder 208 to restore the video bands. As a particular example, the encoded video bands could represent compressed high-pass frames and low-pass frames, and the EZBC decoder 404 may uncompress the high-pass and low-pass frames. Similarly, the motion vectors are provided to a motion vector decoder 406. The motion vector decoder 406 decodes and restores the motion vectors by performing an inverse of the encoding technique used by the motion vector encoder 210.

The restored video bands 416a-416n and motion vectors are provided to a plurality of inverse motion compensated temporal filters (inverse MCTFs) 408a-408n. The inverse MCTFs 408 process and restore the video bands 416a-416n. For example, the inverse MCTFs 408 may perform temporal synthesis to reverse the effect of the temporal filtering done by the MCTFs 204. The inverse MCTFs 408 may also perform motion compensation to reintroduce motion into the video bands 416. In particular, the inverse MCTFs 408 may process the high-pass and low-pass frames generated by the MCTFs 204 to restore the video bands 416. In other embodiments, the inverse MCTFs 408 may be replaced by inverse UMCTFs.

The restored video bands 416 are then provided to an inverse wavelet transformer 410. The inverse wavelet transformer 410 performs a transformation function to transform the video bands 416 from the wavelet domain back into the spatial domain. Depending on, for example, the amount of information received in the bitstream 220 and the processing power of the video decoder 118, the inverse wavelet transformer 410 may produce one or more different sets of restored video signals 414a-414c. In some embodiments, the restored video signals 414a-414c have different resolutions. For example, the first restored video signal 414a may have a low resolution, the second restored video signal 414b may have a medium resolution, and the third restored video signal 414c may have a high resolution. In this way, different types of streaming video receivers 104 with different processing capabilities or different bandwidth access may be used in the system 100.

The restored video signals 414 are provided to a low band shifter 412. As described above, the video encoder 110 processes the input video frames 214 using one or more overcomplete wavelet expansions 218. The video decoder 118 uses previously restored video frames in the restored video signals 414 to generate the same or approximately the same overcomplete wavelet expansions 418. The overcomplete wavelet expansions 418 are then provided to the inverse MCTFs 408 for use in decoding the video bands 416.

Although FIGS. 2-4 illustrate an example video encoder, overcomplete wavelet expansion, and video decoder, various changes may be made to FIGS. 2-4. For example, the video encoder 110 could include any number of MCTFs 204, and the video decoder 118 could include any number of inverse MCTFs 408. Also, any other overcomplete wavelet expansion could be used by the video encoder 110 and video decoder 118. In addition, the inverse wavelet transformer 410 in the video decoder 118 could produce restored video signals 414 having any number of resolutions. As a particular example, the video decoder 118 could produce It sets of restored video signals 414, where 11 represents the number of video bands 416.

FIG. 5 illustrates an example motion compensated temporal filtering according to one embodiment of this disclosure. This motion compensated temporal filtering may, for example, be performed by the MCT's 204 in the video encoder 110 of FIG. 2 or by any other suitable video encoder.

As shown in FIG. 5, the motion compensated temporal filtering involves motion estimation from a previous video frame A to a current video frame B. During temporal filtering, some pixels 502 in a video frame may be referenced multiple times or not referenced at all. This is due, for example, to the motion contained in the video frames and the covering or uncovering of objects in the image. These pixels 502 are typically referred to as “unconnected pixels,” whereas pixels 504 referenced once are typically referred to as “connected pixels.” In typical coding systems, the presence of unconnected pixels 502 in video frames requires special processing that reduces coding efficiency.

To improve the quality of the motion estimation, sub-pixel accuracy motion estimation is employed using a 3D lifting scheme, which may allow more accurate or even perfect reconstruction of compressed video frames. When using spatial domain MCTF at the video encoder 110, if motion vectors have sub-pixel accuracy, the lifting scheme generates a high-pass frame (B) and a low-pass frame (L) for video frames using:
H[m,n]=(B[m,n]−Ã[m−dₘ,n−dₙ])/\sqrt{2} (2)
L[m−\overline{d}ₘ,n−\overline{d}ₙ]=\tilde{H}[m−\overline{d}ₘ+dₘ,n−\overline{d}ₙ+dₙ]+\sqrt{2}A[m−\overline{d}ₘ,n−\overline{d}ₙ[ (3)
where A denotes the previous video frame, B denotes the current video frame, Ã(x,y) denotes an interpolated pixel value at position (x,y) in the A video frame, B(m,n) denotes the pixel value at position (m,n) in the B video frame, (dₘ,dₙ) denotes a sub-pixel accuracy motion vector, and (\overline{d}ₘ,\overline{d}ₙ) denotes an approximal to the nearest integer value lattice.

At the video decoder 118, the previous video frame A is reconstructed from L and H using the following equation:
A[m−\overline{d}ₘ,n−\overline{d}ₙ]=(L[m−\overline{d}ₘ,n−\overline{d}ₙ]−\tilde{H}[m−\overline{d}ₘ+dₘ,n−\overline{d}ₙ+dₙ])/\sqrt{2} (4)
After the previous video frame A has been reconstructed, the current video frame B is reconstructed using the following equation:
B[m,n]=\sqrt{2}H[m,n]+Ã[m−dₘ,n−dₙ] (5)

In this example, unconnected pixels in the current frame B are processed as shown in equation (2), while unconnected pixels in the previous frame A are processed as:
L[m,n]=\sqrt{2}A[m,n] (6)

The use of overcomplete wavelet expansions 218 in a wavelet domain at the video encoder 110 may require interpolation filters in the motion estimators of the MCTFs 204 that can perform sub-pixel motion estimation for each video band 216 in the wavelet domain. In some embodiments, these interpolation filters convolute pixels from adjacent neighbors within a video band 216 and from adjacent neighbors in other bands 216.

As an example, FIG. 6A illustrates an example wavelet decomposition where a video frame 600 is decomposed into four wavelet bands 216 within a single decomposition level. The lifting structure for the overcomplete wavelet domain can be generated by modifying equations (2)-(6). For example, by simply extending equation (2), the high-pass frame for the j-th decomposition level could be represented as:
Hⁱⱼ[m,n]=(Bⁱⱼ[m,n]−Ãⱼⁱ[m−dⁱⱼ(m),n−dⁱⱼ(n)])/\sqrt{2},i=0, . . . ,3 (7)
where dⁱⱼ(m)=dₘ/2^{j}, dⁱⱼ(n)=dₙ/2^{j}, and (dₘ,dₙ) denotes a motion vector in the spatial domain. However, the interpolation of the Aⁱⱼ frame in equation (7) may not be optimal because this does not incorporate the dependencies of the cross-phase wavelet coefficients. Using the interleaving technique described above, a more optimal high-pass frame for the j-th decomposition level could be represented as:
Hⁱⱼ[m,n]=(Bⁱⱼ[m,n]−LBS_{—}Ãⁱⱼ[2^{j}m−dₘ,2^{j}n−dₙ])/\sqrt{2},i=0, . . . ,3 (8)
where LBS_Aⁱⱼ denotes the interleaved overcomplete wavelet coefficients, and LBS_Ãⁱⱼ[2^{j}m−dₘ,n−dₙ] denotes its interpolated pixel value at location [2^{j}m−dₘ,2^{j}n−dₙ]. After interleaving, the interpolation operation represents a simple spatial domain interpolation of the neighboring wavelet coefficients.

Similarly, the low-pass filtered frame could be represented as:
Lⁱⱼ[m−\overline{d}ⁱⱼ(m), n−\overline{d}ⁱⱼ(n)]=LBS_{—}\tilde{H}ⁱⱼ[2^{j}m−\overline{d}ₘ,n−\overline{d}ₙ+dₙ]+\sqrt{2}Aⁱⱼ[m−\overline{d}ⁱⱼ(m), n−\overline{d}ⁱⱼ(n)]i=0, . . . ,3 (9)
where dⁱⱼ(m)=dₘ/2^{j}, dⁱⱼ(n)=dₙ/2ⁱ, and LBS_Hⁱⱼ denotes the interleaved overcomplete wavelet coefficients of the Hⁱⱼ frame.

At the decoder side, reconstruction can be performed using the following equations:
Aⁱⱼ[m−\overline{d}ⁱⱼ(m),n−\overline{d}ⁱⱼ(n)]=Lⁱⱼ[m−\overline{d}ⁱⱼ(m),n−\overline{d}ⁱⱼ(n)]/\sqrt{2}−LBS_{—}\tilde{H}ⁱⱼ[2^{j}m−{overscore (d+EEₘ+dₘ,n−\overline{d}ₙ+dₙ]/\sqrt{2} (10)
Bⁱⱼ[m,n]=\sqrt{2}Hⁱⱼ[m,n]+LBS_{—}Ãⁱⱼ[2^{j}m−dₘ,2^{j}n−dₙ]. (11)

In some embodiments, perfect reconstruction can be obtained at the video decoder 118 when the video encoder 110 and video decoder 118 use the same sub-pixel interpolation technique, no matter which interpolation technique is used at the encoder 110. In this example, unconnected pixels in the current frame B are processed as shown in equation (9), while unconnected pixels in the previous frame A are processed as:
Lⁱⱼ[m,n]=\sqrt{2}Aⁱⱼ[m,n]. (12)

Equation (9) uses the interpolated high-pass frames in order to produce the low-pass frame. As a result, in some embodiments, the four temporal high-pass frames Hⁱⱼ,i=0, . . . ,3 at the same decomposition level are generated using equation (8). After that, the four low-pass frames Lⁱⱼ,i=0, . . . ,3 are generated using the temporal high-pass frames according to equation (9).

The video frames being processed by the video encoder 110 and the video decoder 118 could have more than one decomposition level. For example, FIG. 6B illustrates an example wavelet decomposition, where a video frame 650 is decomposed into two decomposition levels. In this example, the 40 band is decomposed into multiple sub-bands A₂^{j},j=0, . . . ,3. For this or other video frames with multiple decomposition levels, equations (8)-(11) implementing the lifting structure are executed recursively, starting at the lowest resolution image. In other words, equations (8)-(11) are executed once for the sub-bands A₂^{j},j=0, . . . ,3 in the A₁⁰ band. Once completed, equations (8)-(11) are executed again for the bands A_{I}^{J}j=0, . . . ,3.

To summarize, at the video encoder 110, the 3D lifting algorithm for video frames having L decomposition levels is represented as:

H_{L}⁰[m,n]=(B_{L}⁰[m,n]−LBS_Ã_{L}⁰[2^{L}m−dₘ,2^{L}n−dₙ])/\sqrt{2}
L_{L}⁰[m−\overline{d}_{L}⁰(m),n−\overline{d}_{L}⁰(n)]= LBS_\tilde{H}_{L} ⁰[2^{L}m−\overline{d}ₘ+dₘ,n−\overline{d}ₙ+dₙ]+

\sqrt{2}A_{L}⁰[m−\overline{d}_{L}⁰(m),n−\overline{d}_{L}⁰(n)]

for j=L:1

```
  for i=1:3
  Hⱼⁱ[m,n]=(Bⱼⁱ[m,n]−LBS_Ãⱼⁱ[2^{j}m−dₘ,2^{j}n−dₙ])/\sqrt{2}
  end
  for i=1:3
  Lⱼⁱ[m−\overline{d}ⱼⁱ(m),n−\overline{d}ⱼⁱ(n)]= LBS_\tilde{H}ⱼⁱ[2^{j}m−\overline{d}ₘ+dₘ,n−\overline{d}ₙ+dₙ]+
```

\sqrt{2}Aⱼⁱ[m−\overline{d}ⱼⁱ(m),n−\overline{d}ⱼⁱ(n)]

end

reconstruct ^{A}^{_{j−1}}^{⁰} from ^{A}^{ⱼ}^{ⁱ}^{,i=0,...,3}
reconstruct ^{H}^{_{j−1}}^{⁰} from ^{H}^{ⱼ}^{ⁱ}^{,i=0,...,3}

end

Similarly, at the video decoder 118, the 3D lifting algorithm for video frames having L decomposition levels is represented as:

A_{L}⁰[m−\overline{d}_{L}⁰(m),n−\overline{d}_{L}⁰(n)]= L_{L}⁰[m−\overline{d}_{L}⁰(m),n−\overline{d}_{L}⁰(n)]/\sqrt{2}

−LBS_\tilde{H}_{L}⁰[2^{L}m−\overline{d}ₘ+dₘ,n−\overline{d}ₙ+dₙ]/\sqrt{2}

B_{L}⁰[m,n]=\sqrt{2}H_{L}⁰[m,n]+LBS_Ã_{L}⁰[2^{L}m−dₘ,2^{L}n−dₙ]
for j=L:1

for i=1:3
Aⱼⁱ[m−\overline{d}ⱼⁱ(m),n−\overline{d}ⱼⁱ(n)]= Lⱼⁱ[m−\overline{d}ⱼⁱ(m),n−\overline{d}ⱼⁱ(n)]/\sqrt{2}

−LBS_\tilde{H}ⱼⁱ[2^{j}m−\overline{d}ₘ+dₘ,n−\overline{d}ₙ+dₙ]/\sqrt{2}

end
for i=1:3
Bⱼⁱ[m,n]=\sqrt{2}Hⱼⁱ[m,n]+LBS_Ãⱼⁱ[2^{j}m−dₘ,2^{j}n−dₙ].
end
reconstruct ^{A}^{_{j−1}}^{⁰} from ^{A}^{ⱼ}^{ⁱ}^{,i=0,...,3}
reconstruct ^{H}^{_{j−1}}^{⁰} from ^{H}^{ⱼ}^{ⁱ}^{,i=0,...,3}

end

As shown in this summary and in equations (8)-(11) above, if a band at a particular decomposition level is corrupted or lost during transmission from the video encoder 110 to the video decoder 118, reconstruction of the video frames at the decoder 118 incurs errors. This is because equations (8)-(11) would not produce the same reference at the video decoder 118 as they would at the video encoder 110. To provide error resiliency, the extended reference (such as LBS_Aⁱⱼ) is generated from the corresponding sub-band (such as Aⁱⱼ) without shifting the next finer level sub-band. This may increase the robustness of the system 100 and make the video encoder 110 and decoder 118 less complex.

FIG. 7 illustrates an example method 700 for encoding video information using 3D lifting in an overcomplete wavelet domain according to one embodiment of this disclosure. The method 700 is described with respect to the video encoder 110 of FIG. 2 operating in the system 100 of FIG. 1. The method 700 may be used by any other suitable encoder and in any other suitable system.

The video encoder 110 receives a video input signal at step 702. This may include, for example, the video encoder 110 receiving multiple frames of video data from a video frame source 108.

The video encoder 110 divides each video frame into bands at step 704. This may include, for example, the wavelet transformer 202 processing the video frames and breaking the frames into n different bands 216. The wavelet transformer 202 could decompose the frames into one or more decomposition levels.

The video encoder 110 generates one or more overcomplete wavelet expansions of the video frames at step 706. This may include, for example, the low band shifter 206 receiving the video frames, identifying the lower band of the video frames, shifting the lower band by different amounts, and augmenting the lower band together to generate the overcomplete wavelet expansions.

The video encoder 110 compresses the base layer of the video frames at step 708. This may include, for example, the MCTF 204a processing the lowest resolution wavelet band 216a and generating high-pass frames H_{L}⁰ and low-pass frames L⁰_{L}.

The video encoder 110 compresses the enhancement layer of the video frames at step 710. This may include, for example, the remaining MCTFs 204b-204n receiving the remaining video bands 216b-216n. This may also include the remaining MCTFs 204 generating the remaining temporal high-pass frames at the lowest decomposition level using equation (8) and then generating the remaining temporal low-pass frames at that decomposition level using equation (9). This may further include the MCTFs 204 generating additional high-pass frames and low-pass frames for any other decomposition levels. In addition, this may include the MCTFs 204 generating motion vectors identifying movement in the video frames.

The video encoder 110 encodes the filtered video bands at step 712. This may include the EZBC coder 208 receiving the filtered video bands 216, such as the high-pass frames and low-pass frames, from the MCTFs 204 and compressing the filtered bands 216. The video encoder 110 encodes the motion vectors at step 714. This may include, for example, the motion vector encoder 210 receiving the motion vectors generated by the MCTFs 204 and compressing the motion vectors. The video encoder 110 generates an output bitstream at step 716. This may include, for example, the multiplexer 212 receiving the compressed video bands 216 and compressed motion vectors and multiplexing them into a bitstream 220. At this point, the video encoder 110 may take any suitable action, such as communicating the bitstream to a buffer for transmission over the data network 106.

Although FIG. 7 illustrates one example of a method 700 for encoding video information using 3D lifting in an overcomplete wavelet domain, various changes may be made to FIG. 7. For example, various steps shown in FIG. 7 could be executed in parallel in the video encoder 110, such as steps 704 and 706. Also, the video encoder 110 could generate an overcomplete wavelet expansion multiple times during the encoding process, such as once for each group of frames processed by the encoder 110.

FIG. 8 illustrates an example method 800 for decoding video information using 3D lifting in an overcomplete wavelet domain according to one embodiment of this disclosure. The method 800 is described with respect to the video decoder 118 of FIG. 4 operating in the system 100 of FIG. 1. The method 800 may be used by any other suitable decoder and in any other suitable system.

The video decoder 118 receives a video bitstream at step 802. This may include, for example, the video decoder 110 receiving the bitstream over the data network 106.

The video decoder 118 separates encoded video bands and encoded motion vectors in the bitstream at step 804. This may include, for example, the multiplexer 402 separating the video bands and the motion vectors and sending them to different components in the video decoder 118.

The video decoder 118 decodes the video bands at step 806. This may include, for example, the EZBC decoder 404 perform inverse operations on the video bands to reverse the encoding performed by the EZBC coder 208. The video decoder 118 decodes the motion vectors at step 808. This may include, for example, the motion vector decoder 406 performing inverse operations on the motion vectors to reverse the encoding performed by the motion vector encoder 210.

The video decoder 118 decompresses the base layer of the video frames at step 810. This may include, for example, the inverse MCTF 408a processing the lowest resolution bands 416 of the previous and current video frames using the high-pass frames H_{L}⁰ and the low-pass frames L_{L}⁰.

The video decoder 118 decompresses the enhancement layer of the video frame (if possible) at step 812. This may include, for example, the inverse MCTFs 408 receiving the remaining video bands 416b-416n. This may also include the inverse MCTFs 408 restoring the remaining bands of the previous frame at one decomposition level and then restoring the remaining bands of the current frame at that decomposition level. This may further include the inverse MCTFs 408 restoring the frames for any other decomposition levels.

The video decoder 118 transforms the restored video bands 416 at step 814. This may include, for example, the inverse wavelet transformer 410 transforming the video bands 416 from the wavelet domain to the spatial domain. This may also include the inverse wavelet transformer 410 generating one or more sets of restored signals 414, where different sets of restored signals 414 have different resolutions.

The video decoder 118 generates one or more overcomplete wavelet expansions of the restored video frames in the restored signal 414 at step 816. This may include, for example, the low band shifter 412 receiving the video frames, identifying the lower band of the video frames, shifting the lower band by different amounts, and augmenting the lower bands. The overcomplete wavelet expansion is then provided to the inverse MCTFs 408 for use in decoding additional video information.

Although FIG. 8 illustrates one example of a method 800 for decoding video information using 3D lifting in an overcomplete wavelet domain, various changes may be made to FIG. 8. For example, various steps shown in FIG. 8 could be executed in parallel in the video decoder 118, such as steps 806 and 808. Also, the video decoder 118 could generate an overcomplete wavelet expansion multiple times during the decoding process, such as one for each group of frames decoded by the decoder 118.

It may be advantageous to set forth definitions of certain words and phrases that have been used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document. Those of ordinary skill in the art should understand that in many, if not most instances, such definitions apply to prior as well as future uses of such defined words and phrases.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method (700) for compressing an input stream (214) of video frames, comprising:
transforming each of a plurality of video frames into a plurality of wavelet bands in one or more decomposition levels;
performing motion compensated temporal filtering on at least some of the wavelet bands to generate a plurality of high-pass frames and a plurality of low-pass frames, the low-pass frames at each decomposition level generated using the high-pass frames at that decomposition level; and
compressing the high-pass frames and the low-pass frames for transmission over a network (106).

2. The method (700) of claim 1, further comprising:
generating one or more overcomplete wavelet expansions used during the motion compensated temporal filtering;
generating one or more motion vectors during the motion compensated temporal filtering;
compressing the one or more motion vectors; and
multiplexing the compressed high-pass frames, low-pass frames, and one or more motion vectors onto an output bitstream (220).

3. The method (700) of claim 1, further comprising generating an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

4. A method (800) for decompressing a video bitstream (220), comprising:
receiving a video bitstream (220) comprising a plurality of compressed high-pass frames and low-pass frames;
decompressing the compressed high-pass frames and low-pass frames;
performing inverse motion compensated temporal filtering on at least some of the decompressed high-pass frames and low-pass frames to generate a plurality of wavelet bands associated with the video frames, the wavelet bands associated with one or more decomposition levels, the wavelet bands generated starting at a lowest decomposition level; and
transforming the wavelet bands into one or more restored video frames.

5. The method (800) of claim 4, further comprising:
demultiplexing one or more compressed motion vectors and the compressed high-pass frames and low-pass frames from the bitstream (220);
decompressing the one or more compressed motion vectors, the one or more motion vectors used during the inverse motion compensated temporal filtering; and
generating one or more overcomplete wavelet expansions, the one or more overcomplete wavelet expansions used during the inverse motion compensated temporal filtering.

6. The method (800) of claim 4, further comprising generating an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

7. A video encoder (110) for compressing an input stream (214) of video frames, comprising:
a wavelet transformer (202) operable to transform each of a plurality of video frames into a plurality of wavelet bands in one or more decomposition levels;
a plurality of motion compensated temporal filters (204) operable to process at least some of the wavelet bands and generate a plurality of high-pass frames and a plurality of low-pass frames, the low-pass frames at each decomposition level generated using the high-pass frames at that decomposition level; and
an encoder (208) operable to compress the high-pass frames and the low-pass frames for transmission over a network (106).

8. The video encoder (110) of claim 7, further comprising:
a low band shifter (206) operable to generate one or more overcomplete wavelet expansions used by the motion compensated temporal filters (204), the motion compensated temporal filters (204) further operable to generate one or more motion vectors;
a second encoder (210) operable to compress the one or more motion vectors; and
a multiplexer (212) operable to multiplex the compressed high-pass frames, low-pass frames, and one or more motion vectors onto an output bitstream (220).

9. The video encoder (110) of claim 8, wherein the low band shifter (206) is operable to generate an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

10. A video decoder (118) for decompressing a video bitstream (220), comprising:
a decoder (404) operable to decompress a plurality of compressed high-pass frames and low-pass frames contained in the bitstream (220);
a plurality of inverse motion compensated temporal filters (408) operable to process at least some of the decompressed high-pass frames and low-pass frames to generate a plurality of wavelet bands associated with the video frames, the wavelet bands associated with one or more decomposition levels, the wavelet bands generated starting at a lowest decomposition level; and
a wavelet transformer (410) operable to transform the wavelet bands into one or more restored video frames.

11. The video decoder (118) of claim 10, further comprising:
a demultiplexer (402) operable to demultiplex one or more compressed motion vectors and the compressed high-pass frames and low-pass frames from the bitstream;
a second decoder (406) operable to decompress the one or more compressed motion vectors, the inverse motion compensated temporal filters (408) operable to generate the wavelet bands using the one or more motion vectors; and
a low band shifter (412) operable to generate one or more overcomplete wavelet expansions, the one or more overcomplete wavelet expansions used by the inverse motion compensated temporal filters (408).

12. The video decoder (118) of claim 11, wherein the low band shifter (412) is operable to generate an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

13. A video transmitter (102), comprising:
a video frame source (108) operable to provide a stream of video frames;
a video encoder (110) operable to compress the video frames, the video transmitter (102) comprising:
a wavelet transformer (202) operable to transform each of the video frames into a plurality of wavelet bands in one or more decomposition levels;
a plurality of motion compensated temporal filters (204) operable to process at least some of the wavelet bands and generate a plurality of high-pass flames and a plurality of low-pass frames, the low-pass frames at each decomposition level generated using the high-pass frames at that decomposition level; and
an encoder (208) operable to compress the high-pass frames and the low-pass frames; and
a buffer (112) operable to receive and store the compressed video frames for transmission over a network (106).

14. The video transmitter (102) of claim 13, wherein the video encoder (110) further comprises a low band shifter (206) operable to generate one or more overcomplete wavelet expansions used by the motion compensated temporal filters (204), the low band shifter (206) is operable to generate an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

15. A video receiver (104), comprising:
a buffer (116) operable to receive and store a video bitstream;
a video decoder (118) operable to decompress the video bitstream and generate restored video frames, the video decoder (118) comprising:
a decoder (404) operable to decompress a plurality of compressed high-pass frames and low-pass frames contained in the bitstream;
a plurality of inverse motion compensated temporal filters (408) operable to process at least some of the decompressed high-pass frames and low-pass frames to generate a plurality of wavelet bands associated with the video frames, the wavelet bands associated with one or more decomposition levels, the wavelet bands generated starting at a lowest decomposition level; and
a wavelet transformer (410) operable to transform the wavelet bands into one or more restored video frames; and
a video display (120) operable to present the restored video frames.

16. The video receiver (118) of claim 15, wherein the video decoder (118) further comprises a low band shifter (412) operable to generate one or more overcomplete wavelet expansions used by the inverse motion compensated temporal filters (408), the low band shifter (412) operable to generate an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

17. A computer program embodied on a computer readable medium and operable to be executed by a processor, the computer program comprising computer readable program code for:
transforming each of a plurality of video frames into a plurality of wavelet bands in one or more decomposition levels;
performing motion compensated temporal filtering on at least some of the wavelet bands to generate a plurality of high-pass frames and a plurality of low-pass frames, the low-pass frames at each decomposition level generated using the high-pass frames at that decomposition level; and
compressing the high-pass frames and the low-pass frames for transmission over a network (106).

18. A computer program embodied on a computer readable medium and operable to be executed by a processor, the computer program comprising computer readable program code for:
decompressing a plurality of compressed high-pass frames and low-pass frames contained in a video bitstream (220);
performing inverse motion compensated temporal filtering on at least some of the decompressed high-pass frames and low-pass frames to generate a plurality of wavelet bands associated with the video frames, the wavelet bands associated with one or more decomposition levels, the wavelet bands generated starting at a lowest decomposition level; and
transforming the wavelet bands into one or more restored video frames.

19. A transmittable video signal produced by the steps of:
transforming each of a plurality of video frames into a plurality of wavelet bands in one or more decomposition levels;
performing motion compensated temporal filtering on at least some of the wavelet bands to generate a plurality of high-pass frames and a plurality of low-pass frames, the low-pass frames at each decomposition level generated using the high-pass frames at that decomposition level; and
compressing the high-pass frames and the low-pass frames for transmission over a network (106).

20. The video receiver of claim 19, wherein the low band shifter is operable to generate an overcomplete wavelet expansion by:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

21. A computer program embodied on a computer readable medium and operable to be executed by a processor, the computer program comprising computer readable program code for:
transforming each of a plurality of video frames into a plurality of wavelet bands in one or more decomposition levels;
performing motion compensated temporal filtering on at least some of the wavelet bands to generate a plurality of high-pass frames and a plurality of low-pass frames, the low-pass frames at each decomposition level generated using the high-pass frames at that decomposition level; and
compressing the high-pass frames and the low-pass frames for transmission over a network.

22. The computer program of claim 21, further comprising computer readable program code for:
generating one or more overcomplete wavelet expansions used during the motion compensated temporal filtering;
generating one or more motion vectors during the motion compensated temporal filtering;
compressing the one or more motion vectors; and
multiplexing the compressed high-pass frames, low-pass frames, and one or more motion vectors onto an output bitstream.

23. The computer program of claim 22, wherein the computer readable program code for generating one or more overcomplete wavelet expansions comprises computer readable program code for:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

24. A computer program embodied on a computer readable medium and operable to be executed by a processor, the computer program comprising computer readable program code for:
decompressing a plurality of compressed high-pass frames and low-pass frames associated with a plurality of video frames;
performing inverse motion compensated temporal filtering on at least some of the decompressed high-pass frames and low-pass frames to generate a plurality of wavelet bands associated with the video frames, the wavelet bands associated with one or more decomposition levels, the wavelet bands generated starting at a lowest decomposition level; and
transforming the wavelet bands into one or more restored video frames.

25. The computer program of claim 24, further comprising computer readable program code for:
demultiplexing one or more compressed motion vectors and the compressed high-pass frames and low-pass frames from the bitstream;
decompressing the one or more compressed motion vectors, the one or more motion vectors used during the inverse motion compensated temporal filtering; and
generating one or more overcomplete wavelet expansions, the one or more overcomplete wavelet expansions used during the inverse motion compensated temporal filtering.

26. The computer program of claim 25, wherein the computer readable program code for generating one or more overcomplete wavelet expansions comprises computer readable program code for:
shifting a particular one of the wavelet bands a plurality of times to produce a plurality of shifted wavelet bands, the shifted wavelet bands each shifted differently; and
interleaving wavelet coefficients in the particular wavelet band and wavelet coefficients in each of the shifted wavelet bands to produce a set of overcomplete wavelet coefficients that represent the overcomplete wavelet expansion.

27. A transmittable video signal produced by the steps of:
transforming each of a plurality of video frames into a plurality of wavelet bands in one or more decomposition levels;
performing motion compensated temporal filtering on at least some of the wavelet bands to generate a plurality of high-pass frames and a plurality of low-pass frames, the low-pass frames at each decomposition level generated using the high-pass frames at that decomposition level; and
compressing the high-pass frames and the low-pass frames for transmission over a network.
